(19) United States
(12) Patent Application Publication
(10) Pub. No.: US 2026/0012050 A1
(43) Pub. Date: Jan. 8, 2026

(54) ROTOR MAGNET AND BRUSHLESS MOTOR

(71) Applicant: MABUCHI MOTOR CO., LTD., Chiba (JP)

(72) Inventors: Takuya TAKAHASHI, Chiba (JP); Kazuya INOZUME, Chiba (JP)

(21) Appl. No.: 19/134,211

(22) PCT Filed: May 15, 2023
(86) PCT No.: PCT/JP2023/018094

§ 371 Date: May 30, 2025

(51) Int. Cl. H02K 1/2788; H02K 11/215; H02K 15/035; H02K 21/22

(52) U.S. Cl. CPC H02K 1/2788; H02K 11/215; H02K 15/035; H02K 21/22

(57) ABSTRACT

A rotor magnet of the disclosure is provided turnably relative to a substrate to which a stator or a rotation angle sensor is fixed, is disposed so as to face the stator or the rotation angle sensor, and is formed by injection-molding a material mixture of a magnetic material and a resin through a pinpoint gate. The rotor magnet includes a cylindrical portion formed in a cylindrical shape and having a plurality of magnetic poles arranged, and a rib formed in a shape protruding in a radial direction at an end portion of the cylindrical portion in an axial direction. The thickness of the cylindrical portion is smaller than the inner diameter of a tip end portion of the pinpoint gate, and the thickness of the rib is equal to or larger than the inner diameter of the tip end portion of the pinpoint gate.

### TECHNICAL FIELD

The present invention relates to a rotor magnet and a brushless motor including the rotor magnet.

### BACKGROUND ART

Conventionally, a rotor magnet manufactured by injection molding has been known for a rotor used in a motor or a rotary encoder. For example, there has been known a rotor in which a ring-shaped rotor magnet (resin-coupled magnet) is formed by injection-molding a material mixture of a magnetic powder and a thermoplastic resin material and is inserted into a cylindrical rotor yoke and is bonded therein. Patent Literature 1 describes a rotor formed by integrally molding a rotor magnet in a rotor yoke. Such a configuration facilitates weight reduction and thickness reduction of the rotor magnet.

### CITATION LIST

### Patent Literature

Patent Literature 1: JP-A-2005-198447

### DISCLOSURE OF THE INVENTION

### Problems to be Solved by the Invention

Meanwhile, when an attempt is made to form a rotor magnet having a thickness smaller than the inner diameter of a pinpoint gate tip end portion into which a material mixture is injected at the time of injection molding, the injection pressure (pressure of the material mixture in a mold) of the material mixture increases, and the number of rotor magnets which can be manufactured in one charging step decreases. As a result, there is a problem that it is difficult to improve productivity and a cost for manufacturing increases.

One object of the present invention is to provide a rotor magnet and a brushless motor which have been made in light of the problems above and can improve productivity and a cost. Note that the objects of the present invention are not limited to this object, but also include another object of exerting features and effects which can be derived from configurations presented in “DESCRIPTION OF PREFERRED EMBODIMENTS” described below, the features and effects being unobtainable by the known technology.

### Solutions to the Problems

The rotor magnet of the disclosure can be achieved as the following first aspect (application example), and solves at least some of the problems above. The brushless motor of the disclosure can be achieved as the following seventh aspect, and solves at least some of the problems above. Any of the second to sixth aspects is an aspect which can be additionally selected as appropriate, and is an aspect which can be omitted. Any of the second to sixth aspects does not disclose an aspect and a configuration which are essential to the present invention.

First Aspect. A rotor magnet of the disclosure is provided turnably relative to a substrate to which a stator or a rotation angle sensor is fixed, is disposed so as to face the stator or the rotation angle sensor, and is formed by injection-molding a material mixture of a magnetic material and a resin through a pinpoint gate. The rotor magnet includes a cylindrical portion formed in a cylindrical shape and having a plurality of magnetic poles arranged, and a rib formed in a shape protruding in a radial direction at an end portion of the cylindrical portion in an axial direction. The thickness of the cylindrical portion is smaller than the inner diameter of a pinpoint gate tip end portion, and the thickness of the rib is equal to or larger than the inner diameter of the pinpoint gate tip end portion.

Second Aspect. In the first aspect above, the rotor magnet preferably includes, on a rib end surface which is the end surface of the rib in the axial direction, a trace bulged in a substantially circular shape having a size corresponding to the inner diameter of the pinpoint gate tip end portion as the trace of the injection molding of the rotor magnet. The thickness of the cylindrical portion is preferably smaller than the outer diameter of the trace, and the thickness of the rib is preferably equal to or larger than the outer diameter of the trace.

Third Aspect. In the second aspect above, a cylindrical portion end surface, which is the end surface of the cylindrical portion in the axial direction, preferably has a shape protruding toward the substrate in the axial direction with respect to the rib end surface, and the dimension of a step between the rib end surface and the cylindrical portion end surface is equal to or larger than the height dimension of the trace.

Fourth Aspect. In the aspects including the first aspect above, the rib is preferably disposed so as to avoid a boundary between the plurality of magnetic poles as viewed in the axial direction of the rotor magnet.

Fifth Aspect. In the fourth aspect above, the rib is preferably disposed at the center of any one of the magnetic poles as viewed in the axial direction of the rotor magnet.

Sixth Aspect. In the fifth aspect above, the rotor magnet is preferably a polar-anisotropic ring magnet.

Seventh Aspect. The brushless motor of the disclosure is a brushless motor including a stator, a rotor magnet disposed so as to face the stator in a radial direction, and a rotor housing holding the rotor magnet, in which the rotor magnet is formed by injection-molding a material mixture of a magnetic material and a resin through a pinpoint gate. The rotor magnet includes a cylindrical portion formed in a cylindrical shape and having a plurality of magnetic poles arranged, and a rib formed in a shape protruding in the radial direction at an end portion of the cylindrical portion in an axial direction and engaging with the rotor housing. The thickness of the cylindrical portion is smaller than the inner diameter of a pinpoint gate tip end portion, and the thickness of the rib is equal to or larger than the inner diameter of the pinpoint gate tip end portion.

### Effects of the Invention

According to the rotor magnet and the brushless motor of the disclosure, in the rotor magnet including the cylindrical portion having the thickness smaller than the inner diameter of the pinpoint gate tip end portion, the injection pressure of the material mixture upon molding can be decreased by forming the rib having the thickness equal to or larger than the inner diameter of the pinpoint gate tip end portion. As a result, the number of rotor magnets which can be manufactured in one charging process can be increased, and the productivity and the cost can be improved. In addition, occurrence of a molding defect due to an increase in the injection pressure can be prevented, and a product quality can be enhanced.

### BRIEF DESCRIPTION OF THE DRAWINGS

FIG. 1 is an exploded perspective view for describing a brushless motor as an embodiment.

FIG. 2 is a perspective view showing the lower surface side of a rotor magnet shown in FIG. 1.

FIG. 3 is a bottom view of the rotor magnet shown in FIG. 1.

FIG. 4 is a sectional view of the rotor magnet shown in FIG. 1.

FIG. 5 is a sectional view of the rotor housing shown in FIG. 1.

FIG. 6 is a perspective view showing, as an example, an injection molding state of the rotor magnet shown in FIG. 1.

FIG. 7 is a perspective view showing, as an example, an injection molding state of a rotor magnet according to the prior art.

### DESCRIPTION OF PREFERRED EMBODIMENTS

### [1. Configuration]

Hereinafter, a rotor magnet 2 and a brushless motor 10 will be described as an embodiment with reference to the drawings. The rotor magnet 2 of this embodiment is a component included in a rotor used in a motor (for example, brushless motor, brushed motor, or the like) or a rotary encoder. With respect to the definition of the direction in the embodiment, the extending direction of the rotation center axis of the rotor will be referred to as an “axial direction”, and a direction perpendicular to the rotation center axis will be referred to as a “radial direction”. In a plane perpendicular to the rotation center axis of the rotor, a direction along the circumference of a circle centered on the rotation center axis will be referred to as a “circumferential direction”. Note that a side closer to the rotation center axis in the radial direction will be referred to as “radially inside”, and a side farther from the rotation center axis in the radial direction will be referred to as “radially outside”.

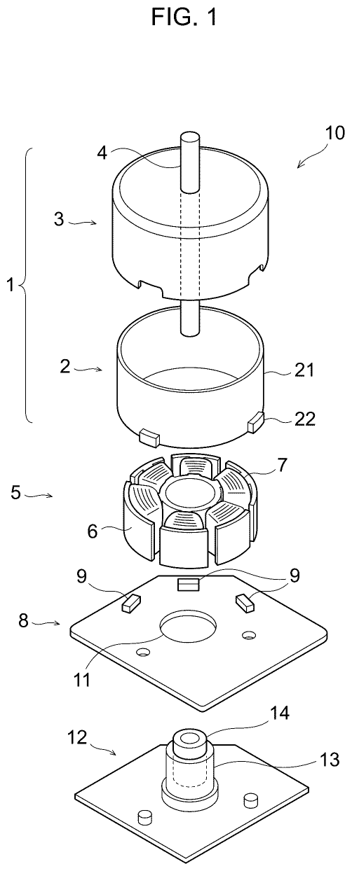

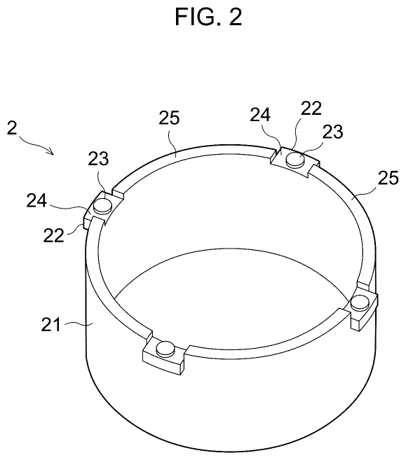

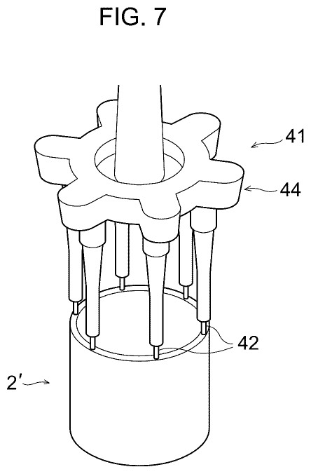

FIG. 1 is an exploded perspective view of the brushless motor 10 including the rotor magnet 2 in the embodiment. Here, a case (casing) forming the exterior of the brushless motor 10 is omitted. FIGS. 2 to 6 are views for describing the configuration of the rotor magnet 2. FIG. 7 is a perspective view showing an injection molding state of a rotor magnet according to the prior art with a molding die omitted for the sake of description. Although the motor shown in FIG. 1 is an outer rotor type brushless DC motor, the rotor magnet 2 of the present embodiment is also applicable to an inner rotor type brushless DC motor. Although the motor shown in FIG. 1 is an 8-pole 6-slot motor, the number of poles and the number of slots of the motor to which the rotor magnet 2 of the present embodiment is applied are not limited thereto.

### (A) Motor

As shown in FIG. 1, the brushless motor 10 of the present embodiment includes a rotor 1, a stator 5, and a substrate 8. The rotor 1 is provided turnably relative to the substrate 8, and the stator 5 is fixed to the substrate 8. The rotor 1 is provided with, for example, a permanent magnet, and the stator 5 is provided with, for example, a coil. A magnetic field is generated by energization to the stator 5, and the rotor 1 rotates under the influence of the magnetic field.

A control circuit (not shown) for controlling the state of the energization to the stator 5 is provided on the substrate 8, and a magnetic sensor 9 (rotation angle sensor, hall IC) for detecting the rotation angle of the rotor 1 is attached to the substrate 8. A desired angular velocity is obtained by controlling the state of the energization to the stator 5 according to the rotation angle of the rotor 1. The position of the magnetic sensor 9 is set to, for example, a position facing the end surface (end surface close to the substrate 8) of the rotor magnet 2 described later. The number of magnetic sensors 9 is set according to, for example, the number of poles and the number of slots of the brushless motor 10.

The rotor 1 is provided with the rotor magnet 2, a rotor housing 3, and an output shaft 4. The rotor magnet 2 is a hollow tubular component formed of a plastic magnet made of a compound (material mixture) of a magnetic material (for example, magnetic powder) and a resin (for example, thermoplastic resin material). The rotor magnet 2 is manufactured by injection-molding the material mixture of the magnetic material and the resin through a pinpoint gate 42 in an injection molding die 41 described later. The pinpoint gate 42 means a hollow which is formed by drilling in a bush which is a component forming an injection port of the injection molding die 41 and serves as a flow path of the injection material. The shape of the pinpoint gate 42 is typically a tapered shape, but is not limited to such a shape. The rotor magnet 2 is disposed so as to face the stator 5 in the radial direction of the rotor 1. In the brushless motor 10 shown in FIG. 1, the rotor magnet 2 is disposed so as to face the stator 5 on the radially outside.

The rotor housing 3 is a hollow tubular component that holds the rotor magnet 2. The rotor magnet 2 is fitted and fixed in the rotor housing 3 shown in FIG. 1. The output shaft 4 serving as the rotation center of the rotor 1 is fixed to the rotor housing 3. The output shaft 4 is turnably supported by a stator holder 12 fixed to the substrate 8 through a bearing 14. A gear, a speed reduction mechanism, and the like (not shown) may be connected to the output shaft 4.

The stator holder 12 is, for example, a member attached to the back side (lower surface in FIG. 1) of the substrate 8, supports the output shaft 4, and fixes the stator 5. The stator holder 12 is provided with a cylindrical stator fixing portion 13 to which the stator 5 is fixed, and the bearing 14 is attached to the tip end side thereof. The stator fixing portion 13 vertically stands on the plate surface of the stator holder 12, is inserted into an opening 11 formed by drilling in the substrate 8 from the back side of the substrate 8, and is provided so as to protrude to the front side (upper surface in FIG. 1) of the substrate 8. The stator 5 is fixed to the substrate 8 by being fitted onto the stator fixing portion 13 of the stator holder 12.

The stator 5 is provided with a multilayer core 6 and a winding 7. The multilayer core 6 is a component formed by stacking a plurality of steel sheets having the same shape. The stacking direction of the steel sheets is the same as the axial direction of the rotor 1 (extending direction of the output shaft 4). The multilayer core 6 is provided with a hollow cylindrical shaft portion fitted onto the outer peripheral surface of the stator fixing portion 13 and a plurality of teeth protruding radially outward from the shaft portion. The plurality of teeth is arranged at equal intervals in the circumferential direction of the shaft portion in a cross section perpendicular to the axial direction of the rotor 1. In the cross section perpendicular to the axial direction of the rotor 1, each tooth is formed in a shape radially extending outward in the axial direction from the shaft portion, and is formed in a shape extending in an arc shape in the circumferential direction from an outer end portion of the shaft portion. An electric wire wound around each tooth is the winding 7 (coil).

### (B) Rotor Magnet

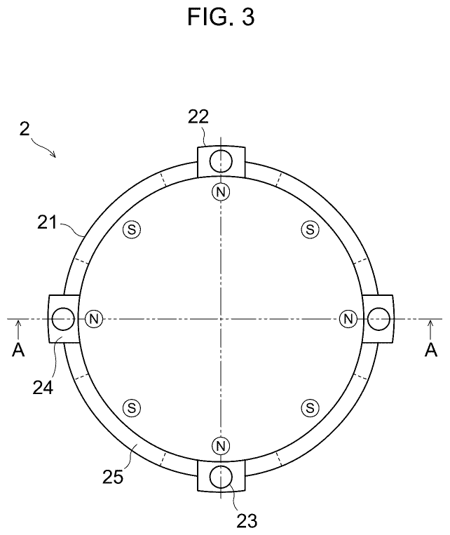

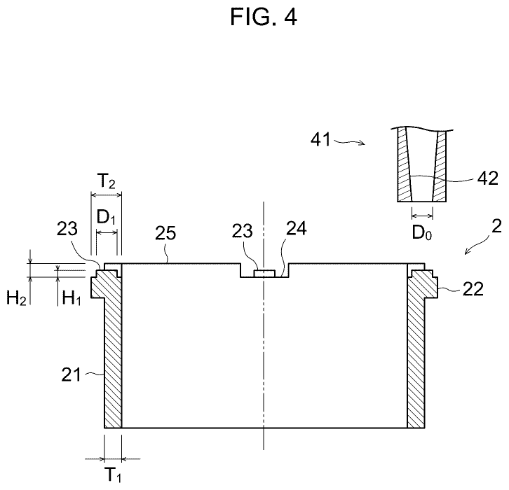

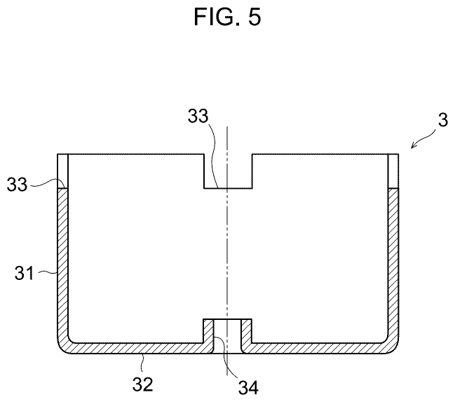

FIG. 2 is a perspective view showing the lower surface side (side close to the substrate 8) of the rotor magnet 2, and FIG. 3 is a bottom view thereof. FIG. 4 is a sectional view (sectional view taken along A-A line in FIG. 3) of the rotor magnet 2, and FIG. 5 is a sectional view of the rotor housing 3 taken along the same cut plane. The rotor magnet 2 is provided with a cylindrical portion 21, a rib 22, and a trace 23. As a principle of generating the trace 23, in the injection molding die 41 (description thereof is omitted), the pinpoint gate 42 is provided in an upper die and the rotor magnet 2 is provided in a lower die, and the pinpoint gate 42 has, for example, a tapered structure in which the diameter thereof decreases toward the tip end on the side close to the rotor magnet 2 (see FIG. 4). As a result, when the upper and lower dies are opened based on a molding process, the material mixture hardened in the pinpoint gate 42 and the rotor magnet 2 hardened in the lower die are vertically separated from each other in the vicinity of a tip end portion (pinpoint gate tip end portion) of the pinpoint gate 42, and the separated portion remains as a trace. For this reason, in FIGS. 2 and 4, the trace 23 is a circular column for convenience and the height thereof is shown to be constant, but actually, the trace 23 is not limited to the circular column and the height is not limited to be constant.

The cylindrical portion 21 is a portion formed in a cylindrical shape, in which a plurality of magnetic poles is arranged. The outer diameter of the cylindrical portion 21 is a dimension corresponding to the inner diameter of the rotor housing 3. As a result, the outer peripheral surface of the cylindrical portion 21 is fitted in the inner peripheral surface of the rotor housing 3. As shown in FIG. 3, the orientation of the magnetic pole is set such that each portion when the cylindrical portion 21 is equally divided in the circumferential direction generates a magnetic field toward a portion adjacent thereto. As described above, the ring magnet in which a magnetic flux is oriented to be biased in the direction along the circumferential direction rather than the radial direction is generally called a polar-anisotropic ring magnet. Although the number of magnetic poles of the rotor magnet 2 shown in FIG. 3 is eight, the specific number of magnetic poles, the specific orientation and density of the magnetic field, and the like can be arbitrarily set in relation to the stator. Note that in the present embodiment, the magnetic pole layout is made such that the magnetic field is densely formed on the radially inside rather than on the radially outside of the rotor magnet 2.

The rib 22 is a portion formed in a shape protruding in the radial direction at an end portion of the cylindrical portion 21 in the axial direction. The rib 22 shown in FIGS. 2 to 4 is formed at a lower-surface-side (side close to the substrate 8) end portion of the rotor magnet 2 at the end portion of the cylindrical portion 21 in the axial direction. The rib 22 includes a plurality of ribs 22 arranged at intervals in the circumferential direction on the outer peripheral surface of the cylindrical portion 21. These ribs 22 are preferably arranged at equal intervals. The number of ribs 22 shown in FIGS. 2 to 4 is four, but the number of ribs 22 can be arbitrarily changed.

The rib 22 has at least two functions. The first function is a function of engaging the rotor magnet 2 and the rotor housing 3 with each other. The rib 22 of the rotor magnet 2 is engaged with a cutout 33 of the rotor housing 3 described later. The second function is a function of sufficiently ensuring the size of an inlet port for the compound supplied through the pinpoint gate 42 of the injection molding die 41 when the rotor magnet 2 is manufactured. The size of the rib 22 is larger than the size of the tip end portion of the pinpoint gate 42.

As shown in FIG. 4, the thickness (dimension in the radial direction) of the cylindrical portion 21 is set to T₁, and the thickness (dimension in the radial direction) of the rib 22 is set to T₂. In addition, the inner diameter of the tip end portion of the pinpoint gate 42 of the injection molding die 41 is set to Do. Each dimension of the rotor magnet 2 of the present embodiment is set such that at least T₁<D₀≤T₂ is satisfied. That is, the thickness T₁ of the cylindrical portion 21 is smaller than the inner diameter Do of the tip end portion of the pinpoint gate 42. On the other hand, the thickness T₂ of the rib 22 is equal to or larger than the inner diameter Do of the tip end portion of the pinpoint gate 42. Note that in FIG. 4, the entire shape of the injection molding die 41 is omitted for the sake of easy understanding of the injection molding structure.

As shown in FIG. 2, the trace 23 is formed on a rib end surface 24 which is the end surface (end surface close to the substrate 8) of the rib 22 in the axial direction. The trace 23 is a portion remaining as the trace of the injection molding of the rotor magnet 2, and is a portion bulged in a substantially circular shape having a size corresponding to the inner diameter Do of the tip end portion of the pinpoint gate 42. As shown in FIG. 4, the outer diameter of the trace 23 is set to D₁. The outer diameter D₁ is substantially the same as the inner diameter Do. Each dimension of the rotor magnet 2 of the present embodiment is set such that T₁<D₁≤T₂ is satisfied.

That is, the thickness T₁ of the cylindrical portion 21 is smaller than the outer diameter D₁ of the trace 23. On the other hand, the thickness T₂ of the rib 22 is equal to or larger than the outer diameter D₁ of the trace 23. Note that the shape of the trace 23 is not necessarily the perfect circular shape, and may be, for example, a cylindrical shape or a partially-missing substantially circular columnar shape. In any case, the shape of the trace 23 is a shape corresponding to the shape of the tip end portion of the pinpoint gate 42, and the outer diameter D₁ of the trace 23 can be regarded as being substantially the same as the inner diameter Do of the tip end portion of the pinpoint gate 42.

As shown in FIG. 2, a cylindrical portion end surface 25 which is the end surface (end surface close to the substrate 8) of the cylindrical portion 21 in the axial direction is formed in a shape protruding toward the substrate 8 in the axial direction more than the rib end surface 24. In other words, the rib end surface 24 is formed in a shape recessed from the cylindrical portion end surface 25. As shown in FIG. 4, the height dimension of the most axially protruding portion of the trace 23 with respect to the rib end surface 24 is set to H₁, and the dimension of a step between the rib end surface 24 and the cylindrical portion end surface 25 is set to H₂. Each dimension of the rotor magnet 2 of the present embodiment is set such that H₁≤H₂ is satisfied. That is, the dimension H₂ of the step between the rib end surface 24 and the cylindrical portion end surface 25 is equal to or larger than the height dimension H₁ of the trace 23.

As shown in FIG. 3, the layout of the ribs 22 as viewed in the axial direction of the rotor magnet 2 is made so as to avoid the boundaries between the plurality of magnetic poles when the rotor magnet 2 is viewed in the axial direction from the end surface side close to the substrate 8. Here, the boundary between the magnetic poles is indicated by a broken line in FIG. 3. The position of the rib 22 in the circumferential direction is set so as not to overlap with at least the boundary between the magnetic poles, which is indicated by the broken line. Preferably, the position of the rib 22 is set so as to be farthest from the boundary between the magnetic poles when the rib 22 is moved in the circumferential direction. In other words, the rib 22 is disposed at the center of any magnetic pole as viewed in the axial direction of the rotor magnet 2.

### (C) Rotor Housing

As shown in FIG. 5, the rotor housing 3 is provided with a side portion 31, an end portion 32, the cutout 33, and a hole 34. The side portion 31 is a cylindrical portion attached so as to surround the outside of the rotor magnet 2, and the inner peripheral surface thereof is formed in a size to be fitted onto the outer peripheral surface of the cylindrical portion 21. The dimension (dimension in an up-down direction in FIG. 5) of the side portion 31 in the axial direction is set to, for example, a size in which the rotor magnet 2 completely fits therein.

The end portion 32 is a disk-shaped portion forming the end surface (end surface apart from the substrate 8) of the side portion 31 in the axial direction. The end portion 32 forms the upper surface of the rotor housing 3 shown in FIG. 1. The cutout 33 is a portion which is cut out in a shape corresponding to the rib 22 of the rotor magnet 2 and in which the rib 22 is fitted. The cutout 33 includes the same number of cutouts 33 as that of the ribs 22, which are arranged at equal intervals in the circumferential direction in the side portion 31. The hole 34 is a circular opening formed by drilling in a center portion of the end portion 32. The output shaft 4 of the rotor 1 is inserted into and fixed to the hole 34.

### [2. Features and Effects]

FIG. 7 is a perspective view showing, as an example, an injection molding state of a rotor magnet 2′ according to the prior art. For the sake of description, the entire shape of the injection molding die 41 is omitted. In the rotor magnet 2′, the thickness T₁ of the cylindrical portion 21 is smaller than the inner diameter Do of the tip end portion of the pinpoint gate 42, and no rib 22 is provided. For this reason, an injection pressure (pressure of the material mixture flowing in the mold) increases, and therefore, mold breakage and burrs at a die joint portion are likely to occur. Therefore, the number of pinpoint gates 42 (the number of gates) for injecting the material mixture into one rotor magnet 2′ needs to be increased, and the number of rotor magnets 2′ which can be manufactured in one charging process is decreased. In the example shown in FIG. 7, the number of gates for one rotor magnet 2′ is six, and the number of rotor magnets 2′ manufactured by one injection molding die 41 is one.

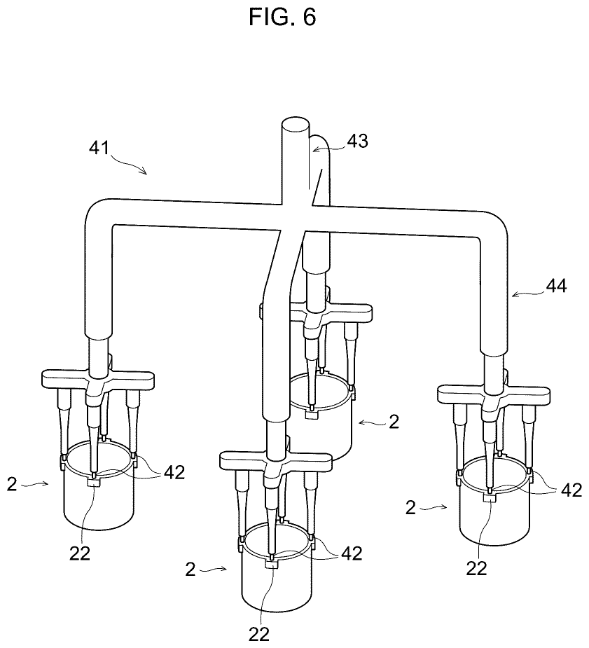

On the other hand, FIG. 6 is a perspective view showing, as an example, the injection molding state of the rotor magnet 2 according to the present embodiment. For the sake of description, the entire shape of the injection molding die 41 is omitted. The material mixture of the magnetic material and the resin flows through the upper die of the injection molding die 41 in this order of a spool 43, a runner 44, and the pinpoint gate 42, and is injected into the rotor magnet 2 in the lower die. In the rotor magnet 2, the rib 22 having the thickness T₂ equal to or larger than the inner diameter Do of the tip end portion of the pinpoint gate 42 is formed. As a result, the injection pressure can be decreased, and the number of gates for one rotor magnet 2 can be decreased. Therefore, the number of rotor magnets 2 which can be manufactured in one charging step is increased, and so-called multi-piece molding is facilitated. In the example shown in FIG. 6, the number of gates for one rotor magnet 2 is four, and the number of rotor magnets 2 manufactured by one injection molding die 41 is four.

(1) The rotor magnet 2 described above is provided turnably relative to the substrate 8 to which the stator 5 is fixed, is disposed so as to face the stator 5, and is formed by injection-molding the material mixture of the magnetic material and the resin through the pinpoint gate 42. The rotor magnet 2 includes the cylindrical portion 21 formed in the cylindrical shape and having the plurality of magnetic poles arranged, and the rib 22 formed in the shape protruding in the radial direction at the end portion of the cylindrical portion 21 in the axial direction. As shown in FIG. 4, the thickness T₁ of the cylindrical portion 21 is smaller than the inner diameter Do of the tip end portion of the pinpoint gate 42, and the thickness T₂ of the rib 22 is equal to or larger than the inner diameter Do of the tip end portion of the pinpoint gate 42.

With such a configuration, the injection pressure of the material mixture during molding can be decreased as compared with the case where no rib 22 is provided. As a result, the number of rotor magnets 2 which can be manufactured in one charging process can be increased, and productivity and a cost can be improved. In addition, occurrence of a molding defect due to an increase in the injection pressure can be prevented, and a product quality can be enhanced. Furthermore, it is not necessary to upgrade the injection molding die 41 or replace the injection molding die 41 with the latest molding die in order to increase the production amount of the rotor magnet 2, and it is possible to improve the productivity of the rotor magnet 2 while effectively using existing production equipment. Note that the effects of the present embodiment can be obtained without depending on the inner diameter Do of the tip end portion of the pinpoint gate 42, but remarkable effects can be obtained particularly when the inner diameter Do is 1.5 mm or smaller.

(2) The rotor magnet 2 described above includes, on the rib end surface 24 which is the end surface of the rib 22 in the axial direction, the trace 23 bulged in the substantially circular shape having the size corresponding to the inner diameter Do of the tip end portion of the pinpoint gate 42 as the trace of the injection molding of the rotor magnet 2. As shown in FIG. 4, the thickness T₁ of the cylindrical portion 21 is smaller than the outer diameter D₁ of the trace 23, and the thickness T₂ of the rib 22 is equal to or larger than the outer diameter D₁ of the trace 23.

By referring to the dimension of the trace 23 corresponding to the tip end portion of the pinpoint gate 42 as described above, it is possible to more reliably grasp that the injection pressure of the material mixture during molding has decreased as compared with the case where no rib 22 is provided, and it is possible to improve the productivity and the cost and enhance the product quality. Further, the productivity of the rotor magnet 2 can be improved by omitting the post-processing (deburring) of the injection molding (i.e., leaving the trace 23). In addition, deformation and breakage of the rotor magnet 2 due to the post-processing of the injection molding can be prevented, and the product quality can be further enhanced.

(3) In the rotor magnet 2 described above, as shown in FIGS. 2 to 4, the rib end surface 24, which is the end surface of the rib 22 in the axial direction, is formed in the shape recessed from the cylindrical portion end surface 25, which is the end surface of the cylindrical portion 21 in the axial direction. In other words, the cylindrical portion end surface 25 has the shape protruding toward the substrate 8 in the axial direction with respect to the rib end surface 24. Moreover, the dimension H₂ of the step between the rib end surface 24 and the cylindrical portion end surface 25 is equal to or larger than the height dimension H₁ of the trace 23.

As described above, the cylindrical portion end surface 25 protrudes toward the substrate 8 in the axial direction with respect to the rib end surface 24, so that the trace 23 can be inside the step between the rib end surface 24 and the cylindrical portion end surface 25. As a result, for example, interference between the magnetic sensor 9 and various electronic components disposed closer to the substrate 8 than the rotor 1 and the trace 23, and deformation and breakage due to contact can be reliably prevented, and the product quality can be improved.

(4) The rib 22 described above is disposed so as to avoid the boundaries between the plurality of magnetic poles as viewed in the axial direction of the rotor magnet 2. Accordingly, the detection accuracy of the rotation angle of the rotor 1 by the magnetic sensor 9 can be improved. Since the magnetic sensor 9 senses the boundary of the magnetic force of the rotor magnet 2, for example, in a case where the rib 22 is formed so as to cross the boundary between the magnetic poles, the distance between the magnetic sensor 9 and the rib end surface 24 increases, and accordingly, the output of the magnetic sensor 9 decreases and the detection accuracy of the rotation angle decreases. Furthermore, since the height of the trace 23, which is on the rib end surface 24, in the axial direction varies depending on the location, the detection accuracy becomes more unstable. On the other hand, by disposing the rib 22 at the position avoiding the boundary between the magnetic poles, such a decrease in the accuracy can be avoided. Therefore, the controllability of the brushless motor 10 can be improved. Note that even when the rotor magnet 2 described above is applied to a motor or a rotary encoder other than the brushless motor 10, it is possible to suppress the decrease in the detection accuracy of the boundary between the magnetic poles due to the rib 22.

(5) The rib 22 described above may be disposed at the center of any magnetic pole as viewed in the axial direction of the rotor magnet 2. In this case, the distance between the rib 22 and the boundary between the magnetic poles as viewed in the axial direction of the rotor magnet 2 can be maximized, and the decrease in the accuracy due to the rib 22 (decrease in the detection accuracy of the magnetic sensor 9) can be minimized. Therefore, the controllability of the brushless motor 10 can be further improved.

(6) As shown in FIG. 3, the rotor magnet 2 described above is the polar-anisotropic ring magnet. The polar-anisotropic ring magnet has such a property that the influence (influence of a change in the distance between the rotor magnet 2 and the magnetic sensor 9 on the detection accuracy of the magnetic sensor 9) of the rib 22 on the magnetic sensor 9 tends to be larger than that of a radial-anisotropic ring magnet. Therefore, by setting the position of the rib 22 in the polar-anisotropic ring magnet to the center of the magnetic pole, it is possible to effectively suppress the decrease in the detection accuracy of the boundary between the magnetic poles due to the rib 22, and to improve the controllability of the brushless motor 10.

(7) The brushless motor 10 described above is the brushless motor 10 including the stator 5, the rotor magnet 2 disposed so as to face the stator 5 in the radial direction, and the rotor housing 3 holding the rotor magnet 2, in which the rotor magnet 2 is formed by injection-molding the material mixture of the magnetic material and the resin through the pinpoint gate 42. The rotor magnet 2 includes the cylindrical portion 21 formed in the cylindrical shape and having the plurality of magnetic poles arranged, and the rib 22 formed in the shape protruding in the radial direction at the end portion of the cylindrical portion 21 in the axial direction and engaging with the rotor housing 3. As shown in FIG. 4, the thickness T₁ of the cylindrical portion 21 is smaller than the inner diameter Do of the tip end portion of the pinpoint gate 42, and the thickness T₂ of the rib 22 is equal to or larger than the inner diameter Do of the tip end portion of the pinpoint gate 42.

With such a configuration, the productivity and cost of the rotor magnet 2 can be improved and the product quality can be improved as compared with the case of providing the rotor magnet 2′ without the rib 22. Therefore, the productivity of the brushless motor 10 can be improved. In addition, an adhesive for bonding the rotor magnet 2 and the rotor housing 3 is not necessary, and the device configuration can be simplified. Therefore, the productivity and cost of the brushless motor 10 can be further improved. Furthermore, by engaging the rib 22 of the rotor magnet 2 with the cutout 33 of the rotor housing 3, it is possible to reduce misalignment of the rotor magnet 2 in the circumferential direction due to rotation of the rotor 1. Therefore, the controllability of the brushless motor 10 can be further improved.

### [3. Others]

The embodiment described above is a mere exemplification. There is no intention to preclude various modifications and application of a technology, which are not explicitly stated in the present embodiment. The configurations of the present embodiment can be modified and carried out in various manners within the scope that does not depart from the purport of the configurations. In addition, the configurations of the present embodiment can be selected as necessary, or can be combined with various configurations of the well-known technologies as appropriate.

In the embodiment above, the outer rotor type brushless motor has been exemplified, but a similar configuration can also be applied to an inner rotor type brushless motor. For example, in an inner rotor type brushless motor in which a stator is disposed in a circular ring shape, a cylindrical portion and a rib may be formed in a rotor magnet disposed so as to face the radially inside of the stator. The rib is formed in a shape protruding radially inward at an end portion of the cylindrical portion in the axial direction, for example. In such a rotor magnet, by setting the thickness of the cylindrical portion to a dimension smaller than the inner diameter of a pinpoint gate and setting the thickness of the rib to a dimension equal to or larger than the inner diameter of the pinpoint gate, features and effects similar to those of the embodiment above can be achieved.

Note that the rotor magnet of the present invention is applicable not only to the brushless motor, but also to a brushed motor and a rotary encoder. The rotor magnet applied to the rotary encoder may be one provided turnably relative to a substrate 8 to which a rotation angle sensor (for example, magnetic sensor, optical sensor, electrostatic sensor, or the like) is fixed, disposed so as to face the rotation angle sensor, and formed by injection-molding a material mixture of a magnetic material and a resin through a pinpoint gate. In such a rotor magnet, by setting the thickness of the cylindrical portion to a dimension smaller than the inner diameter of a pinpoint gate and setting the thickness of the rib to a dimension equal to or larger than the inner diameter of the pinpoint gate, features and effects similar to those of the embodiment above can be achieved.

### INDUSTRIAL APPLICABILITY

The present invention can be used in an industry of manufacturing a rotor magnet used for a motor or a rotary encoder, and can be used in an industry of manufacturing a brushless motor.

### DESCRIPTION OF REFERENCE SIGNS

1 Rotor
2 Rotor magnet
3 Rotor housing
4 Output shaft
5 Stator
6 Multilayer core
7 Winding
8 Substrate
9 Magnetic sensor (rotation angle sensor)
10 Brushless motor
11 Opening
12 Stator holder
13 Stator fixing portion
14 Bearing
21 Cylindrical portion
22 Rib
23 Trace
24 Rib end surface
25 Cylindrical portion end surface
31 Side portion
32 End portion
33 Cutout
34 Hole
41 Injection molding die
42 Pinpoint gate
43 Spool
44 Runner
Do Inner diameter of pinpoint gate tip end portion
D₁ Outer diameter of trace
T₁ Thickness of cylindrical portion
T₂ Thickness of rib
H₁ Height dimension of trace

H₂ Dimension of step between cylindrical portion end surface and rib end surface

1. A rotor magnet provided turnably relative to a substrate to which a stator or a rotation angle sensor is fixed, disposed so as to face the stator or the rotation angle sensor, and formed by injection-molding a material mixture of a magnetic material and a resin through a pinpoint gate, the rotor magnet comprising:
a cylindrical portion formed in a cylindrical shape and having a plurality of magnetic poles arranged; and
a rib formed in a shape protruding in a radial direction at only one of two end portions of the cylindrical portion in an axial direction, wherein
a thickness of the cylindrical portion is smaller than an inner diameter of a pinpoint gate tip end portion, and
a thickness of the rib is equal to or larger than the inner diameter of the pinpoint gate tip end portion.

2. The rotor magnet according to claim 1, further comprising: a trace bulged in a substantially circular shape having a size corresponding to the inner diameter of the pinpoint gate tip end portion as a trace of injection molding of the rotor magnet on a rib end surface which is an end surface of the rib in the axial direction, wherein
the thickness of the cylindrical portion is smaller than an outer diameter of the trace, and
the thickness of the rib is equal to or larger than the outer diameter of the trace.

3. The rotor magnet according to claim 2, wherein a cylindrical portion end surface, which is an end surface of the cylindrical portion in the axial direction, has a shape protruding toward the substrate in the axial direction with respect to the rib end surface, and
a dimension of a step between the rib end surface and the cylindrical portion end surface is equal to or larger than a height dimension of the trace.

4. The rotor magnet according to claim 1, wherein the rib is disposed so as to avoid a boundary between the plurality of magnetic poles as viewed in the axial direction of the rotor magnet.

5. The rotor magnet according to claim 4, wherein the rib is disposed at a center of any one of the magnetic poles as viewed in the axial direction of the rotor magnet.

6. The rotor magnet according to claim 5, wherein the rotor magnet is a polar-anisotropic ring magnet.

7. A brushless motor comprising: a stator; a rotor magnet disposed so as to face the stator in a radial direction; and a rotor housing holding the rotor magnet, wherein the rotor magnet is formed by injection-molding a material mixture of a magnetic material and a resin through a pinpoint gate,
the rotor magnet has a cylindrical portion formed in a cylindrical shape and having a plurality of magnetic poles arranged, and a rib formed in a shape protruding in the radial direction at an end portion of the cylindrical portion in an axial direction and engaging with the rotor housing,
a thickness of the cylindrical portion is smaller than an inner diameter of a pinpoint gate tip end portion,
a thickness of the rib is equal to or larger than the inner diameter of the pinpoint gate tip end portion, and
an outer peripheral surface of the cylindrical portion is fitted in an inner peripheral surface of the rotor housing.
